(19) United States
(12) Patent Application Publication
(10) Pub. No.: US 2007/0135951 A1
(43) Pub. Date: Jun. 14, 2007

(54) Systems and methods for conducting skill-based game tournaments

(76) Inventors: Pinhas Romik, Rehovot (IL); Robert Ciaffone, Saginaw, MI (US); Charles Humphrey, Lakewood, CO (US); Jose Damiani, Paris (FR); Julien Gaviard, Colombes les vallees (FR)

Correspondence Address: KED & ASSOCIATES, LLP, P.O. Box 221200, Chantilly, VA, 20153-1200, US

(21) Appl. No.: 11/606,378

(22) Filed: Nov. 30, 2006

Related U.S. Application Data
(63) Continuation-in-part of application No. 11/184,000, filed on Jul. 18, 2005.

(51) Int. Cl. G06F 19/00

(52) U.S. Cl. 700/91; 463/13

(57) ABSTRACT

A method of conducting card, dice, or tile game tournaments that involve some element of chance or luck includes comparing the players with the same cards, dice results or tiles to one another to determine who played most skillfully, given the cards they were dealt. The tournament format is suitable for poker, blackjack, and other games, including, without limitation, backgammon, craps and roulette that involve some element of chance or luck.

This application is a continuation-in-part of U.S. application Ser. No. 11/184,000, which was filed Jul. 20, 2005, the contents of which are hereby incorporated by reference.

### BACKGROUND

1. Field

The invention relates to methods of conducting game tournaments where players play games that when conducted in the standard fashion involve luck or chance. More specifically, the invention relates to methods of conducting the tournaments such that the players must use skill, not luck or chance, to win.

2. Background

Many popular card, dice, and tile games being played today involve some element of luck or chance to determine the winner. Such card games include poker, as well as many others. Dice games may include backgammon. Tile games may include scrabble. In such games, the outcome of an individual game is strongly affected by the luck-distributing effect of the cards, dice, or tiles. For example, when a randomly shuffled deck of cards is employed, the random arrangement of the cards can have a significant or controlling effect on who wins particular hands of the game, regardless of the skill of the players. When a card game tournament is conducted where the players play card games that involve luck or chance, such as poker or blackjack, the luck or chance can determine who wins the tournament. This can be frustrating for highly skilled players. In addition, if the players are gambling with actual money during the tournaments, or prizes are being awarded, the tournament play is subject to many government regulations.

### BRIEF DESCRIPTION OF THE DRAWINGS

Embodiments will be described in detail with reference to the following drawings, in which like reference numerals refer to like elements, and wherein:

FIG. 1 is a diagram of two tables at which players are playing a card game tournament;

FIG. 2 is another diagram of two tables at which players are playing a card game tournament;

FIG. 3 is a table showing the results of betting at five tables after a first deal has been played during a tournament;

FIG. 4 is a table showing the results of betting at five tables after a second deal has been played during a tournament;

FIG. 5 is a table showing the results of betting at five tables after a third deal has been played during a tournament;

FIG. 6 is a table showing the total points won by each player at five tables after a predetermined number of deals have been played at all tables;

FIG. 7 is a table showing how the players seated at the same positions at each of the tables compare to one another in terms of the total points they earned during the predetermined number of hands;

FIG. 8 is a table illustrating how carryover points could be awarded to particular players as they advance from one session of tournament play to the next; and

FIGS. 9A and 9B illustrate an electronic device that could be used by a player during tournament play;

FIG. 10 shows a deck-holder to securely store up to ten pre-ordered card decks; and

FIG. 11 illustrates how a tournament with 270 initial players could be conducted.

### DETAILED DESCRIPTION

The following description explains various ways that a tournament could be conducted where the players play a poker game commonly referred to as Texas Hold'em. However, in other embodiments that fall within the scope of the invention the players could play any other sort of card, dice or tile game that, without regard to the methods discussed herein, involves significant elements of luck or chance. For instance, the players could be playing another version of poker, blackjack, or any other sort of card, dice or tile game where luck or chance is involved. Thus, the following description of an embodiment relating to playing Texas Hold'em poker should not be considered in any way limiting.

In a typical deal of Texas Hold'em poker, each player at the table receives two cards face down (“hole cards”), and then five cards are placed in the center of the table, face up (“community cards”). In the end, each player will use his hole cards and the community cards to make the best possible five-card poker hand. During play there are four rounds of betting. The first round takes place after the hole cards are distributed. The second round of betting takes place after the first three community cards (“flop”) are revealed. The fourth community card (“turn”) is then revealed, and a third round of betting takes place. Finally, the fifth community card (“river”) is revealed and the fourth and last round of betting takes place. At that point, the players remaining in the game compare their best five-card poker hands to determine the winner of the deal.

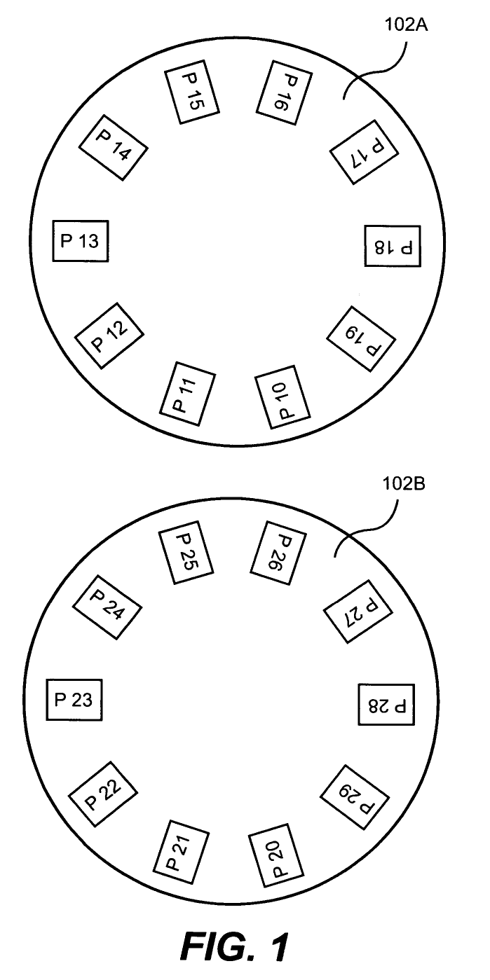

In a first embodiment of a tournament where Texas Hold'em poker is played, there will be at least two tables of multiple players. FIG. 1 shows two tables, each of which has ten players, however other equal number of players at each table is possible (Texas Hold'em may be played with as few as 2 players per table and, theoretically, as many as 22 players per table.) Each position at each table is identified by a two digit code “XY,” where the first number X indicates the table, and the second number Y indicates the player's position at his table. Thus, player number 11 will be seated at table 1, position 1. Player number 21 will be seated at table 2, position 1.

Play of each deal will involve identically ordered pre-determined decks of cards at each table, where a deal has been either dealt at random or preset, and then duplicated for use at the other tables. As a result, once the cards are dealt, the players seated at the same positions at all tables will receive the same cards. Also, the community cards in the center of the table will be the same at all tables. So, for instance, players 15 and 25, who are seated at the fifth position at tables 1 and 2, respectively, will be playing the same hole cards against the other players at their tables. In fact, for each deal all of the players at a given seat position will be playing exactly the same cards as the players in the same seat position at all other tables.

During each deal, the players will all start with the same number of “hand chips.” For instance, for each deal, all players could start with T20,000 worth of chips (where “T” stands for “tournament” rather than any dollar amount, since hand chips have no correlation to actual dollar amounts.) The individual cards would be distributed to the players, and the players would conduct the betting process as noted above. At end of the deal, the number of hand chips won or lost by each player will be determined and recorded.

Once a deal is finished, all players in all seat positions at all tables will have their respective hand chips restored to the previous starting amount, say T20,000. Thus, during each deal, every player always starts with the same number of hand chips.

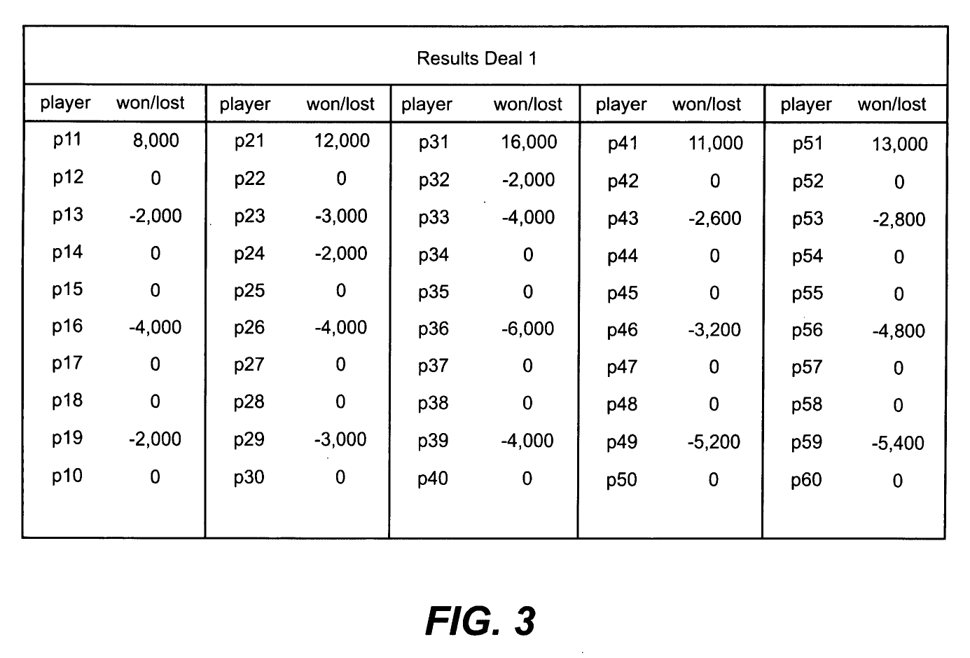

As play progresses, the bets of each player would be recorded, and the results of each deal would be recorded. FIG. 3 shows the results of a deal played by 50 tournament players who are seated at five tables of ten players each. As shown in FIG. 3, after the first deal, the players at position 1 were declared the winner of his table. Because each and every position at all five tables received the same cards, it will be certain that position 1 would be the winner at each table if all hands were played to the end. However, it is possible that the player who would have been the winner may not be in contention for the pot at the end of the deal, since the player may chose to fold his hand at some point. For instance, at some tables player at position 1 may yield to the pressure from some other bluffing player at his table. Also, the exact result may differ at each table even if the same position at each table were to win the pot. This is because the amount of the bet may be selected by the player, and almost always varies from table to table, so the amount that each and every player wins and loses on that deal will seldom be identical at each table even when the same position wins the pot.

In the example shown in FIG. 3, player 11 won +T8,000, player 21 won +T12,000, player 31 won +T16,000, player 41 won +T11,000, and player 15 won +T13,000. Thus, among the players at position 1, the player at table 3 won the most hand chips. Conversely, the player at table 1 won the least. A similar analysis is applied to the players in all of the other positions based on the amount of hand chips they each won or lost on the deal.

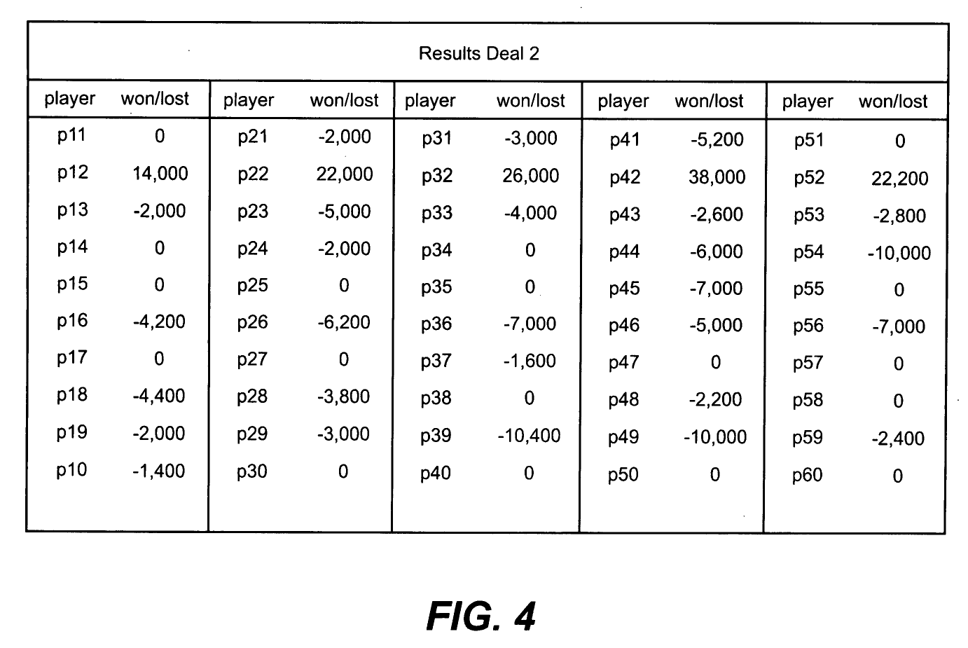

Once the results of the first deal are recorded, the players at each table would play a second deal. Here again, the decks of cards used at each of the five tables would be identically ordered and each player's starting number of hand chips is restored to T20,000. Thus, the players at the same positions would again receive the same cards and have identical amounts of hand chips with which to play the new deal. The betting would occur, and at the end of the second deal, a comparison of the hand chips won or lost by the players in the various positions is again made. FIG. 4 illustrates the results of the second deal.

As shown in FIG. 4, the players at position 2 won or lost varying amounts of hand chips. The results varied from a low of +T14,000 at table 1, to a high of +T38,000 at table 4. Player number 39 lost the most, −T10,400.

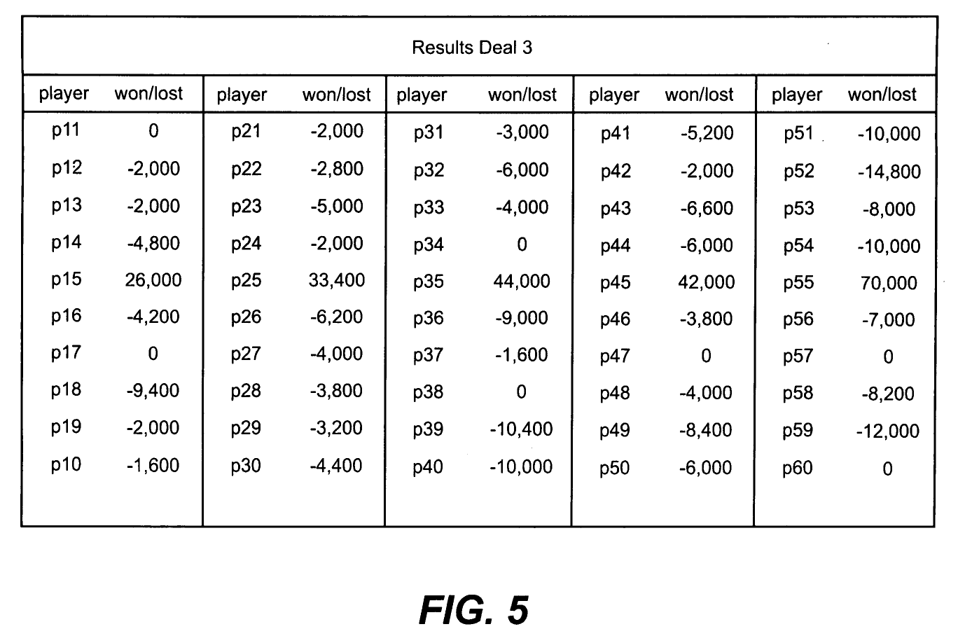

FIG. 5 shows the results of a third deal. As shown therein, the players at position 5 were the winners. Player number 55 at the fifth table won the most, and player 15 at the first table the least. Player number 52 did the worst, ending the deal with only −T14,800.

Play would progress in this fashion until a predetermined number of deals are completed. That predetermined number of deals would constitute a first session. The results of each deal would be recorded, along with the player's bets. This information would preferably be recorded in a computer system in real-time as the play progresses. As will be explained below, the recording of the bets and deal results could be accomplished in various different ways.

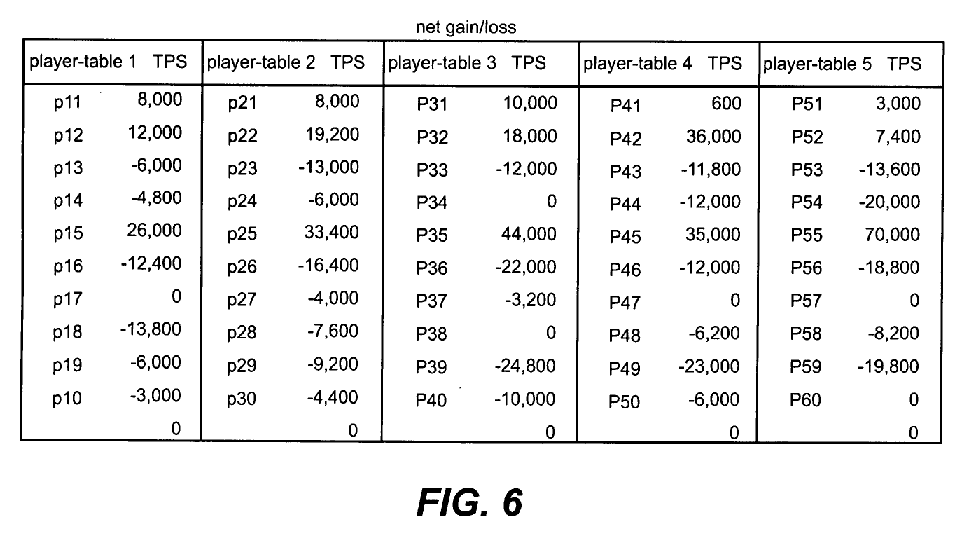

Once all deals in the first session are complete, the recorded information would be used to award points to the players. The calculations used to award points could take many different things into account. Some variations are discussed below. However, the simplest way to make the calculation of total points is to simply add up the total amounts of hand chips each of the players won or lost for the deals played in the session. At the end of the session the total points won or lost in every deal are added and a cumulative result of the session is calculated. Thus, at the end of the session, some players will be net positive, and some players will be net negative. FIG. 6 illustrates the total points awarded to all players for a session of play under this method based on the number of hand chips won or lost on the deals shown in FIGS. 3, 4, and 5.

Although the total amount of points thus determined by each of the players will vary, to determine the players with the best skill, it is necessary to compare how each player at a given position did with respect to the other players at the same position who played the same hole cards. So, for instance, the results for the player at position 6 of table 1 would be compared to the results for the players at position 6 at tables 2-5. Because the players at position 6 were all playing the same cards, which eliminates the “luck of the draw” element normally present in games like poker, the relative results achieved by the players at position 6 provide an indication of the players' skill levels.

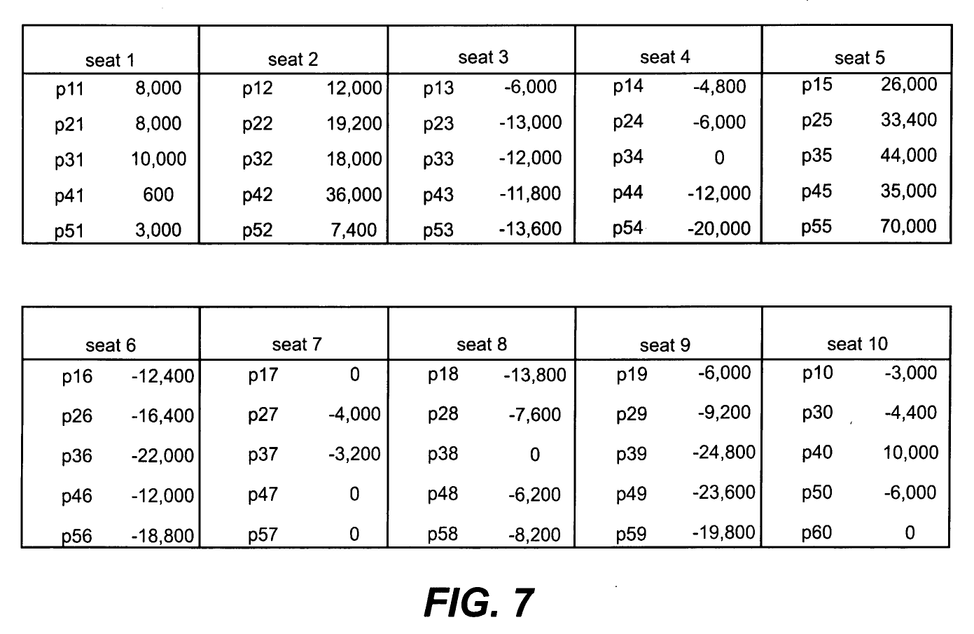

FIG. 7 illustrates the total points achieved by the players organized in a different fashion. In FIG. 7, the players are grouped according to their positions at the tables. Thus, all the players at position 1 are grouped together in the upper left portion of the FIG. 7. As noted above, all of the players at position 1 were playing the same hole cards against other players who also had exactly the same hole cards. However, player number 41 at table 4 received the least points, while player number 31 at table 3 received most.

During a full tournament, several sessions would be played, with each session comprised of a predetermined number of deals. At the end of each session, the player's total points would be determined, and the players who were playing the same cards would be compared to one another. At the end of each session, a pre-determined number of those players who performed poorly at each position, relative to the other players with the same cards, would be eliminated from play. The better-performing players at each position would advance to the next session of the tournament. Because the players at each different position are ranked by comparing them only to those other players at the same position, and because top-ranked players from each position advance to the next session of the tournament, it becomes immaterial if the players at one position had more favorable cards than the players at the other positions, thus making good and bad hole cards count equally for the purpose of advancing in a tournament. This process would continue until only a select few players remain. At the end of play, the winners could be determined in multiple different ways, some of which are discussed below.

For instance, in some embodiments, session play would continue until only six players remain. The six players would play at three tables, where two players are seated at each table. A session of deals would be conducted, and the total points would be calculated for the six players. Then, the points would be used to determine a first, second and third place winner for each of the two table positions. Two players (one from each position) would take first place, two players (one from each position) would take second place, and two players (one from each position) would take third place. Each of the two winners in each place would be paid equally. This declaration of two winners would ensure that even during the final session, the results of play are being compared only to other people who played the same cards. This prize distribution method of having co-winners that each receives the same amount of money thus completely eliminates any luck element that is provided by getting better cards than one's opponents.

Of course, other variations could also be used to determine the winners. For instance, after the results of the final session are determined, the session results could be used with other data to determine the winners. Other alternatives could include considering the total points for each player from all sessions or the total number of deals won by each of the players. These and many other data items could be used in a final calculation to determine winners.

In one embodiment, a tournament would consist of five qualifying sessions to eliminate players. The remaining players would then play in a semi-final session to eliminate more players, and the players remaining after the semi-final session would play a final session as described above to determine the ultimate winners. Embodiments employing qualifying schemes that divide the total field onto primary advancing groups and secondary advancing groups are possible.

In tournament play as described above, the players may be awarded carryover points from one session to another session. If carryover awards are allowed, the players with the best performances in one session would be awarded pre-defined numbers of carryover points into the next session.

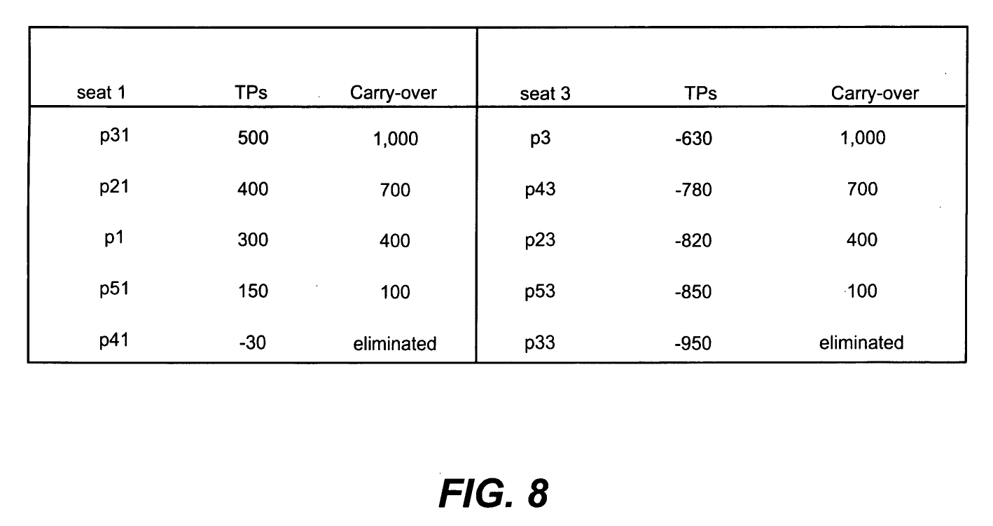

FIG. 8 shows an example of how carryover points could be awarded to players. FIG. 8 shows the final results for five players in position 1 and five players in position 3 after a session of play. For the players at position 1, player number 31 did the best, and player 41 did the worst. For the players at position 3, player number 13 did the best, and player number 33 did the worst. Other numbers of carryover points could be awarded to the winners, and carryover points could vary from session to session.

In a particular tournament embodiment, the worst players in each position would be eliminated, and the remaining players would advance to the next session. For the players who advance, the best player at each position would be allowed to carryover 1,000 points. The next-best player at each position would carryover 700 points, the next best players would carryover 400 points, and the fourth place players at each position would carryover 100 points.

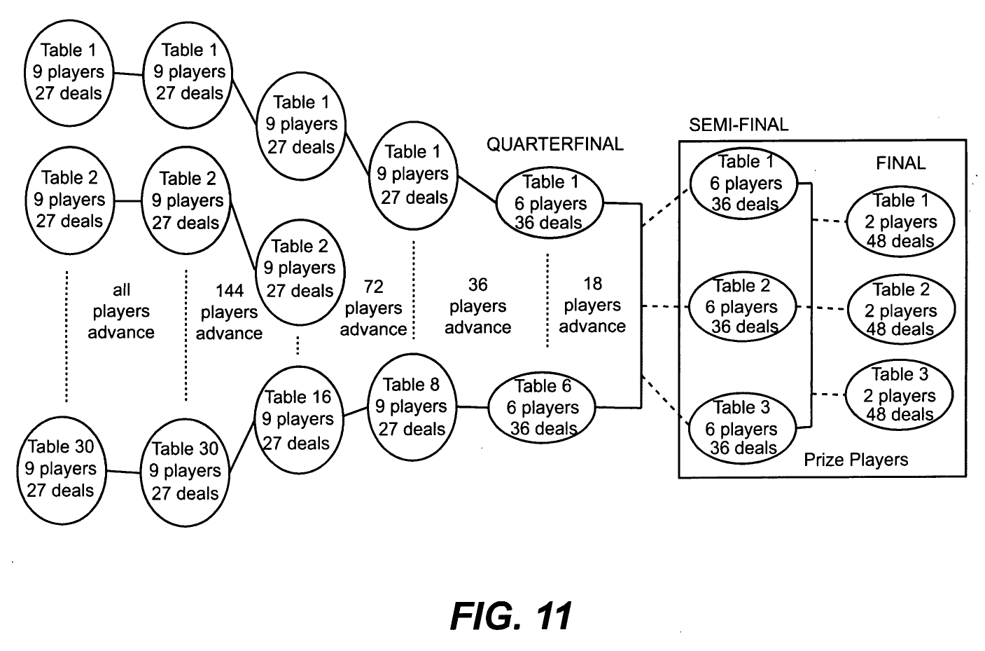

FIG. 11 illustrates a particular embodiment of tournament play in which the tournament would begin with 270 players. The players would begin the first session at thirty tables of nine players each. There would be four qualifying sessions of twenty seven deals each, and one qualifying session of 36 deals.

At the end of the first session all the players would advance to the second session, however carryover points awarded to top-ranked players at each position at the end of the first session could create differences in each player's beginning total points at the start of the second session. These players will be arranged in thirty tables of nine players each. At the end of the second session, one hundred and forty four players would advance to the third session.

At the beginning of the third session, the one hundred and forty four remaining players would be arranged at sixteen tables of nine players each. The one hundred and forty four players would play the third session, and at the end, only seventy two players would advance to the fourth session.

During the fourth session, the seventy two players would be arranged at eight tables of nine players each. At the end of the fourth session, only thirty six players would advance to the fifth session.

During the fifth session, the thirty six players would be arranged at six tables with six players each. At the end of the fifth session, eighteen players would advance to the semi-final round.

During the semi-final round, the eighteen players would be arranged at three tables of six players each. At the end of the semi-final round, only six players would advance to the final round.

During the final round, the six players would be arranged at three tables of two players each. At the end of the final round, there would be two first place players, two second place players and two third place players.

During the semi-final and final rounds, there may be a different number of deals because play will progress faster with fewer players present at the table. For instance, the semi-final and final rounds could comprise 36 or 48 deals. Of course, the number of deals could vary in any of the sessions.

In some embodiments, the prize money could be awarded to more players than just the two first place, two second place and two third place players. For instance, some amount of prize money could be awarded to the participants of the semi-final round that do not advance to the final round. In that instance, one amount of prize money could be awarded to the lowest-scoring six players that do not advance to the final round, and a different, higher amount could be awarded to the six players in the middle positions who do not advance. Separate prizes could be awarded to the session winners of each position, in addition to the players who had the best overall performance.

In some embodiments, during session play, the player designated as the “dealer” could be rotated around the table. As a result, the player who begins the betting would change after each deal.

Also, in some embodiments, the player who begins the betting for a deal might be required to bet a predetermined “blind” amount. These blind amounts could vary from deal to deal within a session, and also from session to session. There might also be a second “blind” amount that the second player betting on a deal must bet. The second blind amount could be the same as the first blind amount, or a higher value.

For instance, during a session, the blind amounts could be T100/T200 for first and second blind bets. In other embodiments during a thirty deal session, the blind amounts could be T100/T$200 for the first ten deals, T200/T400 for the second ten deals, and T300/T600 for the last ten deals. In subsequent sessions the blind amounts could be different. For instance, in a tournament as described above, the above-listed blind bets could be used for the five qualifying sessions, and blind bets in the semi-final and final sessions could be at four different levels, with the last ten deals having a T400/T800 blind.

In some embodiments, there may be a rule that requires players losing more than a predetermined amount of hand chips in any one session to be eliminated prior to the end of the session. Such a rule would discourage wild play from some players that might tend to skew the results for other players. Such a rule could be applied if the cumulative losses over the course of a session result in a player having lost a pre-determined number of hand chips and having lost a pre-determined number of hand chips greater than the average hand chip count of other players with whom the subject player is being compared.

At the end of some sessions, there may be people within a single position that have the same number of points. If, according to the rules, one player must be eliminated while the other advances to the next session, there could be tie-breaker rules. For instance, if two players from the same table position have the same number of points at the end of the session, the player with the best results from earlier sessions might be allowed to advance. Of course, many other tie breaking methods could also be used.

Because actual cards will be dealt at the tables, there is a possibility of misdeals. There could be various different rules in place to account for misdeals. For instance, the average deal winnings/losings for that deal in a particular player's position at other tables could be used as the result assigned to the player at the table where the deal irregularity occurred. Of course, many other methods could be used to account for a misdeal.

As noted above, as play progresses during each session, each player's bets would be recorded, and the results of each deal would be recorded. The betting and final results for each deal could be recorded in many different fashions.

In some embodiments, a recorder would be present at each table and the betting and deal results would be recorded into a computer system in real-time. Of course, the recorder could manually record the betting and results, and the manual records could be used to manually calculate results, or the manual records could be entered into a computer system after a session has ended. In preferred embodiments, the scorer would record the bets and results into a computer system in real time.

In some embodiments, the entries being made by the scorer could be shown to the table dealer on a display screen. This would allow the dealer to verify the information being recorded by the scorer. In addition, the information being recorded by the scorer might also be displayed to the players via one or more displays. This would provide another mechanism for errors to be caught before play progresses.

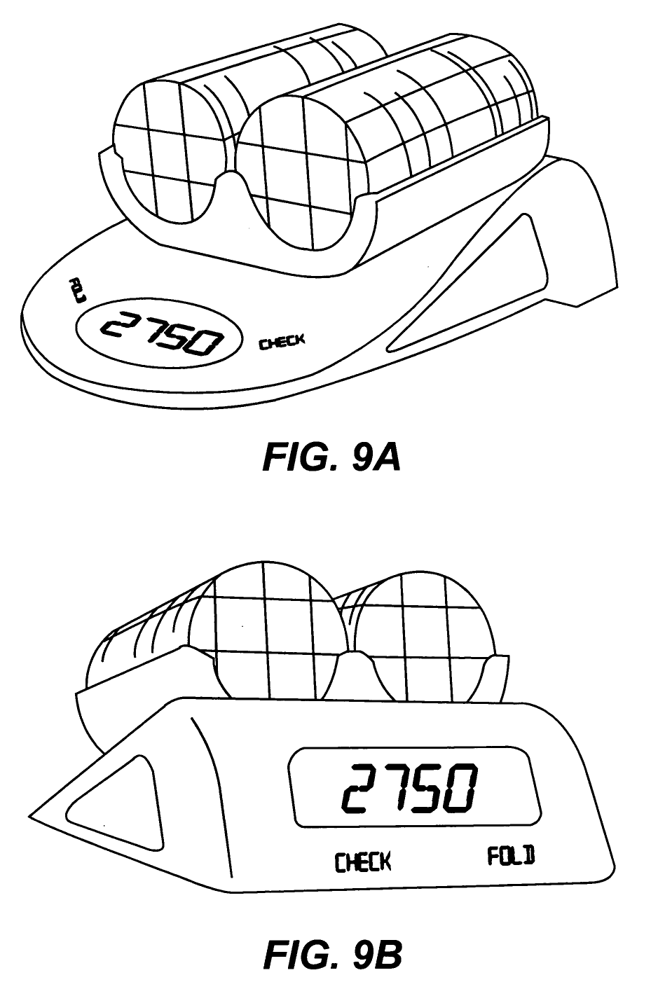

In some embodiments, electronic devices could be located in front of each player, and the devices could be used to help input the information about betting. One embodiment of such a device is shown in FIGS. 9A and 9B.

The electronic device to be used by each player would have a unique identification number. The device would be capable of electronically sending information about the player's bets to the central computer system. The data transfer could be done via a wired connection, or via a wireless link.

At the beginning of each deal, the player would have his chips stacked on the top of the electronic device. The weight of the chips or the presence of individual chips could be sensed by the device. For instance, a light sensor could be located underneath each chip position, such that when a chip is present, light is blocked, and when a chip is removed, light hits the sensor. Of course, many other methods and sensors could be used to sense the presence of the chips. As the player plays a deal, and removes chips from the device to make a bet, the number of chips removed, which would equal the player's bet, would be communicated to the central computer.

The electronic device could also have buttons that a player would press to indicate a check or a fold. The device might also include a display to indicate the number of chips remaining, or the number of chips removed (equal to the player's total bet). Indicator lights could also be provided on the front face of the device so that other players at the table could see if the player decided to check or fold.

In some embodiments, if the betting and deal results are being recorded in real time, the central computer system could tabulate the results of each deal as soon as the deal has ended. To prevent any possibility of cheating, all tables would need to finish a particular deal before the next deal could begin. This means that the computer system could publish results and player rankings at the end of each deal. Of course, in some embodiments, it may be desirable to deliberately withhold the results until a session is completed by all players.

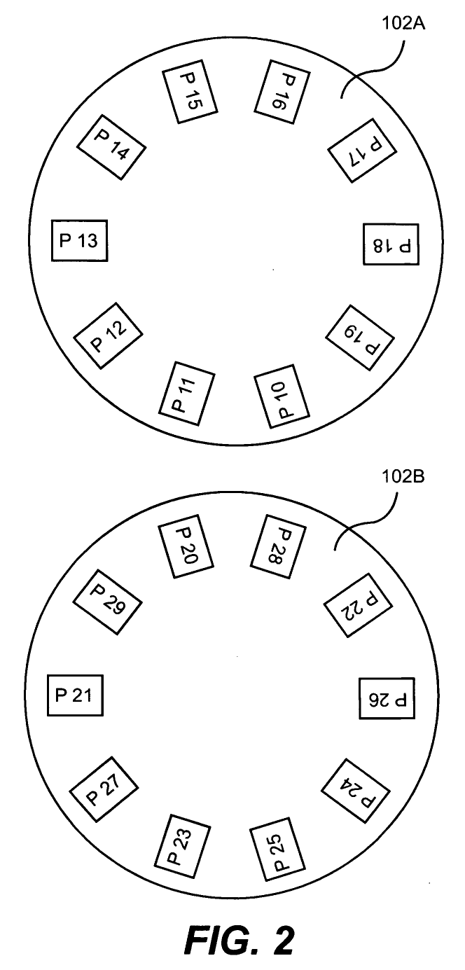

Another way to help prevent cheating would be to distribute the players having the same cards to different locations around the table. For instance, in the arrangement shown in FIG. 2, the players at the first and second tables who are playing the same cards are not arranged in exactly the same positions at the two tables. Player number 11 would be playing the same cards as player 21, but as shown in FIG. 2, players 11 and 21 are at different physical locations at the two tables. In order to achieve these different seating positions, the decks of cards for the two tables would have to be arranged in different orders. However, because the end results to be achieved are known ahead of play, the cards could be pre-arranged to achieve the seating positions shown in FIG. 2. Then, the computer would simply compare the results of play among those players who played the same cards, as explained above.

In different sessions of a tournament, it would be desirable to move players around to different tables to ensure that they confront as many different players in the tournament as possible. Likewise, it is desirable to ensure that each player is compared to as many different other players as possible. This means ensuring that the players playing the same cards are not always the same from session to session. The mixture of different players at tables and the comparison of different players to one another could be achieved, in part, by having the computer system make seating assignments for the players.

The fact that the cards that will be played by the players are known to tournament personnel, but not to any of the players, ahead of time can be useful, particularly if the tournament play is to be televised. If a particularly interesting hand of cards is to be played, it could be possible to show multiple players in a split screen mode, where each player is playing the same set of cards. Thus, the viewer could readily see how different players react to the same set of cards.

In addition, because the betting and play is recorded in detail during the tournament, it is possible to provide the players with a great deal of information once the tournament is complete. For instance, a player could log into an Internet site and review his own play, as well as that of other players. A player might review the tournament play to see how other players reacted to the same cards that he was dealt. Such a review function could also be used by non-players to see how others played during the tournament.

Also, because the decks will all be pre-ordered ahead of time, it would be possible to prepare materials ahead of the tournament to show how the play progressed. Such materials could be distributed to players immediately after the end of a given session or after the tournament has ended.

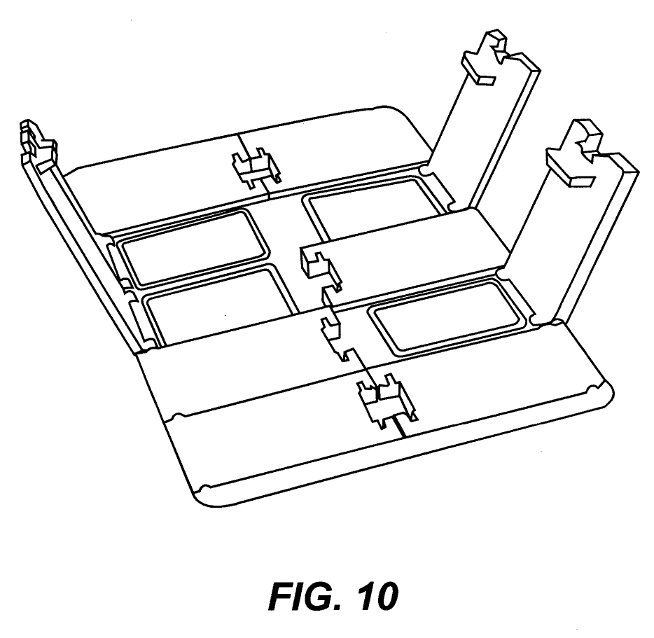

Pre-ordering of the cards in the deals to be played must be conducted in an automatic manner to preserve security of the deals and ensure error-free duplication of all the decks across all the tables. In certain embodiments such ordering of the cards could be executed with duplication machines like those used to duplicate cards for the game of bridge. Ordering of the cards in the deals for the game of poker using bridge duplication machines requires special techniques to operate the machine, such techniques guaranteeing randomness and security developed by the inventors of this patent application. FIG. 10 shows a deck-holder especially developed to securely store up to ten pre-ordered decks. This deck-holder is used to store the pre-ordered decks of cards which are then “dealt” by the dealer at the playing table to each of the players.

In other embodiments pre-ordering of the cards could be done by a special machine which will read an electronic file of the deal and order the cards in the deck in accordance with the electronic file. This machine can be placed at, or incorporated into, a poker playing table and decks of pre-ordered cards can be directly delivered individually to the dealer for “dealing” to the players at the table. The machine could be connected via network (wired or wireless) to other machines at different tables. All the machines could thus receive at the same time the same electronic file of the deal to be pre-ordered, order the deck, and the dealer would then deal the cards to the players. In this embodiment there is no need to pre-package pre-ordered decks in a deck-holder, the deals generated by table machines are delivered directly to the dealer for “dealing” to the players.

As noted above, although the foregoing examples all relate to poker, many other games that involve a luck element introduced by the shuffling of cards, rolling of dice or distribution of tiles could be played in the same tournament fashion. The key is to compare players to one another after eliminating the “luck” element to determine who is playing skillfully. In this sort of a tournament, even a player who received poor cards, for example, and who lost all his deals, could still advance in play if he simply lost the least amount relative to the other similarly situated players.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of conducting a card game tournament, comprising:
1. arranging players at least two tables;
2. dealing the same set of cards to players at corresponding positions of the at least two tables;
3. allowing the players to play the dealt cards to determine a winner of the deal;
4. repeating steps 2 and 3 a predetermined number of times;
5. recording the results of the play as play progresses; and
6. comparing the performance of players at corresponding positions of the at least two tables to one another to determine the relative skill of the players.
